(19) United States
(12) Patent Application Publication
(10) Pub. No.: US 2024/0381419 A1
(43) Pub. Date: Nov. 14, 2024

(54) SCHEDULING ENHANCEMENTS FOR TRANSMIT OPPORTUNITY SHARING

(71) Applicant: QUALCOMM Incorporated, San Diego, CA (US)

(72) Inventors: Abdel Karim AJAMI, San Diego, CA (US); Alfred ASTERJADHI, San Diego, CA (US); George CHERIAN, San Diego, CA (US); Abhishek Pramod PATIL, San Diego, CA (US); Yanjun SUN, San Diego, CA (US); Sai Yiu Duncan HO, San Diego, CA (US); Gaurang NAIK, San Diego, CA (US)

(21) Appl. No.: 18/314,804

(22) Filed: May 9, 2023

(51) Int. Cl. H04W 74/08

(52) U.S. Cl. CPC H04W 74/0808

(57) ABSTRACT

This disclosure provides methods, components, devices and systems for Transmit Opportunity (TXOP) Sharing (TXS) enhancements. In some cases, a wireless node may transmit a first frame that includes a request for a network allocation vector (NAV) setting associated with a shared transmission opportunity (TXOP), receive a second frame triggering the shared TXOP, and communicate, during the shared TXOP, with the NAV set in accordance with the request.

### TECHNICAL FIELD

This disclosure relates generally to wireless communication, and more specifically, to techniques for scheduling transmit opportunity (TXOP) sharing scenarios.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods and devices of this disclosure each have several innovative aspects, no single one of which is solely responsible for the desirable attributes disclosed herein.

One innovative aspect of the subject matter described in this disclosure may be implemented as a method for wireless communications at a first wireless node. The apparatus includes at least one processor; memory coupled with the processor; and instructions stored in the memory and executable by the processor to cause the first wireless node to: output, for transmission, a first frame that is configured to: allow, during a transmit opportunity (TXOP) shared with a second wireless node, a third wireless node to transmit to the second wireless node, and prevent transmission from a fourth wireless node during the shared TXOP; and perform one or more actions during the shared TXOP.

Another innovative aspect of the subject matter described in this disclosure may be implemented at an apparatus for wireless communications at a second wireless node. The apparatus includes at least one processor; memory coupled with the processor; and instructions stored in the memory and executable by the processor to cause the second wireless node to: obtain a first frame that is configured to: allow, during a transmit opportunity (TXOP) shared with the second wireless node by a first wireless node, a third wireless node to transmit to the second wireless node, and prevent transmission from a fourth wireless node during the shared TXOP; and perform one or more actions during the shared TXOP.

Another innovative aspect of the subject matter described in this disclosure may be implemented at an apparatus for wireless communications at a wireless node. The apparatus includes at least one processor; memory coupled with the processor; and instructions stored in the memory and executable by the processor to cause the wireless node to: output, for transmission, a first frame that includes a request for a network allocation vector (NAV) setting associated with a shared transmission opportunity (TXOP); obtain a second frame triggering the shared TXOP; and communicate, during the shared TXOP, with the NAV set in accordance with the request

Another innovative aspect of the subject matter described in this disclosure may be implemented at an apparatus for wireless communications at a wireless node. The apparatus includes at least one processor; memory coupled with the processor; and instructions stored in the memory and executable by the processor to cause the wireless node to: obtain a first frame that includes a request for a network allocation vector (NAV) setting associated with a shared transmission opportunity (TXOP); output a second frame triggering the shared TXOP; and communicate, during the shared TXOP, in accordance with the request.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example physical layer PDU (PPDU) usable for communications between a wireless AP and one or more wireless STAs.

FIG. 4 shows a pictorial diagram of another example wireless communication network.

FIG. 5 shows an example scenario in which TXOP sharing may be utilized.

FIG. 6 shows an example scenario in which TXOP sharing may be utilized.

FIG. 7 shows a timing diagram illustrating an example of TXOP sharing.

FIG. 8 shows a timing diagram illustrating an example of TXOP sharing with NAV setting, in accordance with certain aspects of the present disclosure.

FIGS. 9A and 9B show diagrams illustrating example shared TXOP scenarios with a NAV setting mechanism, in accordance with certain aspects of the present disclosure.

FIG. 10 shows an example frame format, in accordance with certain aspects of the present disclosure.

FIG. 11 shows a timing diagram illustrating an example of TXOP sharing with NAV setting, in accordance with certain aspects of the present disclosure.

FIG. 12 shows a timing diagram illustrating an example of TXOP sharing with NAV setting, in accordance with certain aspects of the present disclosure.

FIG. 13 shows an example frame format, in accordance with certain aspects of the present disclosure.

FIG. 14 shows a flowchart illustrating an example process performable by a first wireless node configured as an AP.

FIG. 15 shows a flowchart illustrating an example process performable by a second wireless node configured as a STA.

FIG. 16 shows a flowchart illustrating an example process performable by a first wireless node configured as an AP.

FIG. 17 shows a flowchart illustrating an example process performable by a second wireless node configured as a STA.

FIG. 18 shows a block diagram of an example wireless communication device.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to wireless communication. Some aspects more specifically relate to techniques for determining a network allocation vector (NAV) for a shared transmit opportunity (TXOP).

TXOP sharing generally refers to a mechanism that allows a station (referred to herein as a TXOP sharing station) that has obtained a TXOP (e.g., gains access to a wireless medium for a duration) to share part of the TXOP with another station (referred to herein as a TXOP shared station). For example, an access point (an AP) could share a TXOP with another AP, an AP could share a TXOP with a non-AP station (a STA) or a STA could share a TXOP with another STA. In some cases, a (non-AP) STA may also share a TXOP with the AP. As used herein, the term STA may refer to an AP STA or a non-AP STA. For convenience, however, an AP STA may sometimes be referred to herein as simply an AP, while a non-AP STA may sometimes be referred to as simply a STA.

Shared TXOPs may be triggered by transmission of a certain type of frame, for example, that indicates a recipient (the station sharing the TXOP) and a duration. This type of triggered TXOP sharing mechanism may be used to serve low latency traffic. For example, TXOP sharing may be used to serve traffic originating in real time applications, such as extended reality (XR) or gaming, that has stringent latency requirements (e.g., 1-10 ms). Meeting such stringent latency requirements may be challenging in wireless networks where stations contend for access to the wireless medium.

When sharing a TXOP, a Sharing AP may assume that all devices in the network have set their network allocation vector (NAV) to a duration indicated in the (trigger) frame that triggered the shared TXOP. Stations maintain one or more NAV timers that dictate when a wireless medium is considered busy or idle. A shared TXOP STA typically acknowledges receipt of a TXOP trigger frame by sending a clear to send (CTS) frame, which may also serve as an indicator to other STAs they should set their NAV.

There are potential challenges for NAV allocation during a shared TXOP. One potential challenge is how to set a NAV to an optimal duration for certain traffic needs. For example, if a NAV is set to a duration that is too long during a shared TXOP (e.g., for the entire duration of the shared TXOP), uplink traffic from another device associated with the shared TXOP STA and another device (e.g., traffic from an XR headset to a phone) may be suppressed, impacting performance and user experience. Another potential challenge is how to ensure that a STA, outside the range of a shared TXOP recipient, sets its NAV appropriately. For example, because the STA is outside the range, it may not receive the CTS from the shared TXOP STA and may, thus, ignore the NAV and transmit potentially interrupting the shared TXOP.

Aspects of the present disclosure, however, propose solutions that may be considered enhancements for NAV setting for TXOP sharing scenarios and may help address these potential challenges. Certain aspects of the present disclosure provide a signaling mechanism where a STA may indicate (e.g., to a potential TXOP sharing AP) a particular (desired/preferred) NAV setting for a shared TXOP. For example, the STA may request a short NAV setting if it wishes to conduct peer-to-peer (P2P) communications during the shared TXOP. Once the shorter NAV duration expires, the shared TXOP STA may trigger uplink traffic from a peer, in a remaining portion of the shared TXOP.

Certain aspects of the present disclosure provide a mechanism that may help ensure that a STA that is out of range of a shared TXOP STA is able to set its NAV appropriately. Because such a STA is at risk of missing the CTS from the shared TXOP STA acknowledging the shared TXOP trigger frame, an additional (or alternative) frame may be sent from an (AP or non-AP) STA sharing the TXOP. In some cases, this frame may have a receive address (RA) set to an address associated with the shared TXOP STA and may be designed to allow a peer device to transmit to the shared TXOP STA during the shared TXOP, while protecting such transmissions. For example, this frame may help ensure NAV setting at the (AP or non-AP) STA that is out of range of the shared TXOP STA to prevent transmissions therefrom during the shared TXOP.

The NAV setting enhancements proposed herein may, thus, result in better utilizing wireless resources and reduced shared TXOP interruption, which may improve performance and user experience. The techniques may increase efficiency in P2P scenarios, coordinated AP scenarios, and other types of BSS transmissions.

### Example Wireless Communication Network

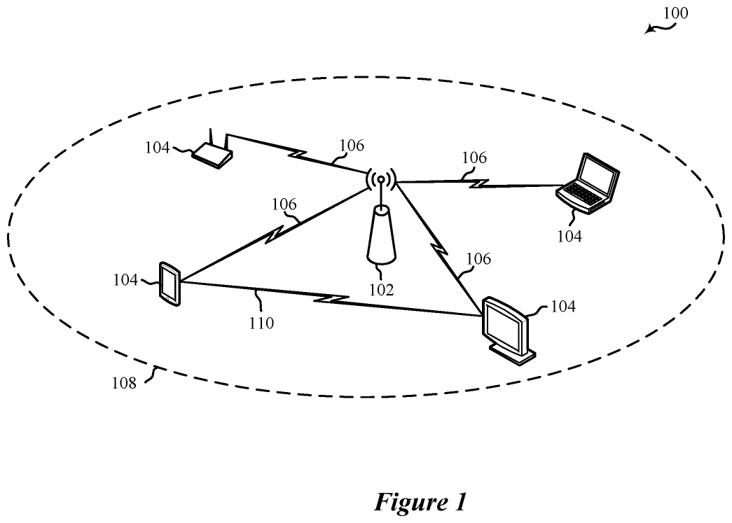

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless access point (AP) 102 and multiple wireless stations (STAs) 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHZ or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHZ and the 6 GHZ bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHZ, 5 GHZ or 6 GHZ bands, each of which is divided into multiple 20 MHz channels. As such, these PPDUs are transmitted over a physical channel having a minimum bandwidth of 20 MHZ, but larger channels can be formed through channel bonding. For example, PPDUs may be transmitted over physical channels having bandwidths of 40 MHZ, 80 MHZ, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload

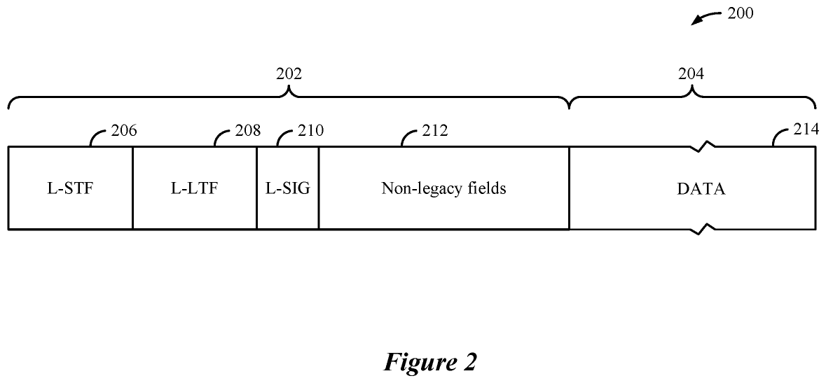

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

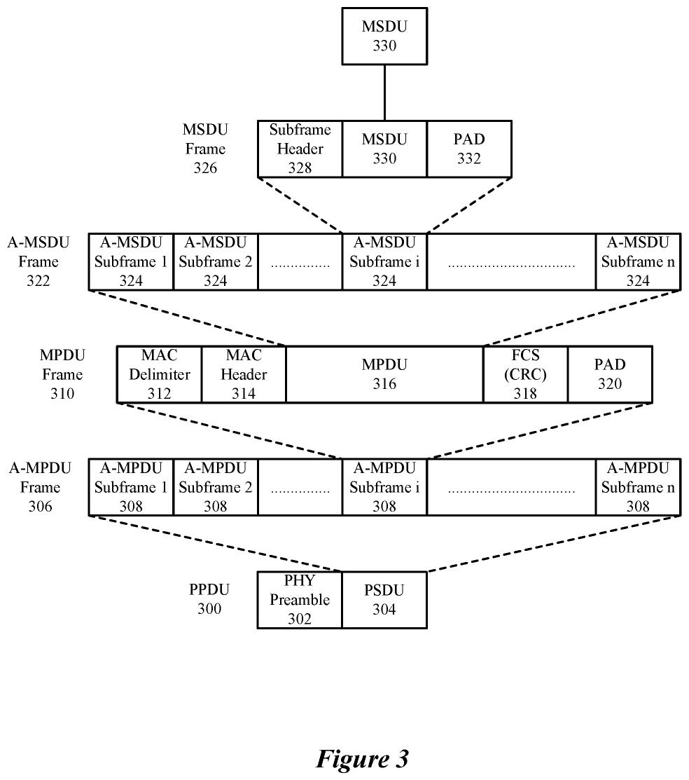

FIG. 3 shows a hierarchical format of an example PPDU usable for communications between a wireless AP 102 and one or more wireless STAs 104. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field may include a cyclic redundancy check (CRC)) and padding bits 320. The MPDU 316 may carry one or more MAC service data units (MSDUs) 316. For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body 316. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body 316. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

Some APs and STAs may implement techniques for spatial reuse that involve participation in a coordinated communication scheme. According to such techniques, an AP may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some other examples of OFDMA techniques, each portion of the plurality of portions of the TXOP includes a set of frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units (RUs) associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or EDCA techniques. Additionally, by enabling a group of APs associated with different BSSs to participate in a coordinated AP transmission session, during which the group of APs may share at least a portion of a single TXOP obtained by any one of the participating APs, such techniques may increase throughput across the BSSs associated with the participating APs and may also achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, an RX power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

Retransmission protocols, such as hybrid automatic repeat request (HARQ), also may offer performance gains. A HARQ protocol may support various HARQ signaling between transmitting and receiving wireless communication devices as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, If a receiving device cannot properly decode (and cannot correct the errors) a first HARQ transmission received from the transmitting device, the receiving device may transmit a HARQ feedback message to the transmitting device (for example, a negative acknowledgement (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an ARQ protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

Some wireless communication devices (including both APs and STAs) are capable of multi-link operation (MLO). In some examples, MLO supports establishing multiple different communication links (such as a first link on the 2.4 GHz band, a second link on the 5 GHz band, and the third link on the 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

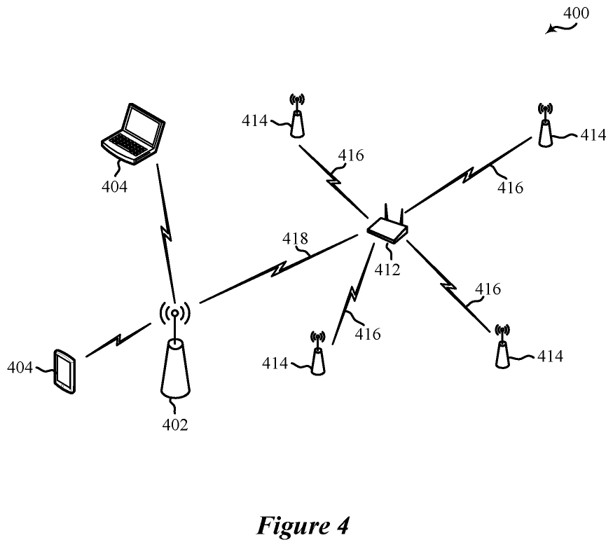

FIG. 4 shows a pictorial diagram of another example wireless communication network 400. According to some aspects, the wireless communication network 400 can be an example of a mesh network, an IoT network or a sensor network in accordance with one or more of the IEEE 802.11 family of wireless communication protocol standards (including the 802.11ah amendment). The wireless network 400 may include multiple wireless communication devices 414. The wireless communication devices 414 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 414 sense, measure, collect or otherwise obtain and process data and then transmit such raw or processed data to an intermediate device 412 for subsequent processing or distribution. Additionally or alternatively, the intermediate device 412 may transmit control information, digital content (for example, audio or video data), configuration information or other instructions to the wireless communication devices 414. The intermediate device 412 and the wireless communication devices 414 can communicate with one another via wireless communication links 416. In some examples, the wireless communication links 416 include Bluetooth links or other PAN or short-range communication links.

In some examples, the intermediate device 412 also may be configured for wireless communication with other networks such as with a Wi-Fi WLAN or a wireless (for example, cellular) wide area network (WWAN), which may, in turn, provide access to external networks including the Internet. For example, the intermediate device 412 may associate and communicate, over a Wi-Fi link 418, with an AP 402 of a WLAN network, which also may serve various STAs 404. In some examples, the intermediate device 412 is an example of a network gateway, for example, an IoT gateway. In such a manner, the intermediate device 412 may serve as an edge network bridge providing a Wi-Fi core backhaul for the IoT network including the wireless communication devices 414. In some examples, the intermediate device 412 can analyze, preprocess and aggregate data received from the wireless communication devices 414 locally at the edge before transmitting it to other devices or external networks via the Wi-Fi link 418. The intermediate device 412 also can provide additional security for the IoT network and the data it transports.

### Example NAV Setting

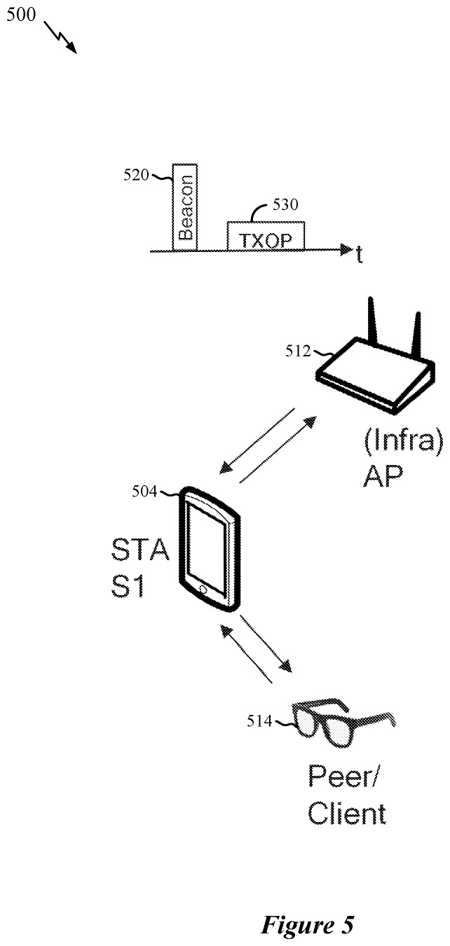

As noted above, traffic originating from real time applications, such as XR or gaming, may have stringent latency requirements. For example, FIG. 5 shows an example scenario 500 in which traffic between a wireless station (STA S1) 504 and a peer device (e.g., an XR headset) 514 may have stringent latency requirements. To accommodate such traffic, an AP 512 (e.g., in infrastructure or “Infra” AP) may broadcast information in beacons (520) indicating how transmit opportunities (TXOPs) 530 may be shared.

In certain wireless communications standards (e.g., 802.11be), such traffic may be referred to as latency sensitive traffic. In scenarios involving latency sensitive traffic, a triggered transmission opportunity (TXOP) sharing mechanism may be used to serve low latency traffic (e.g., XR traffic). For example, a mechanism called a triggered TXOP sharing procedure may be used for such scenarios, allowing an AP to allocate a portion of the time within an obtained TXOP to only one non-AP STA for transmitting one or more non trigger-based (non-TB) PPDUs.

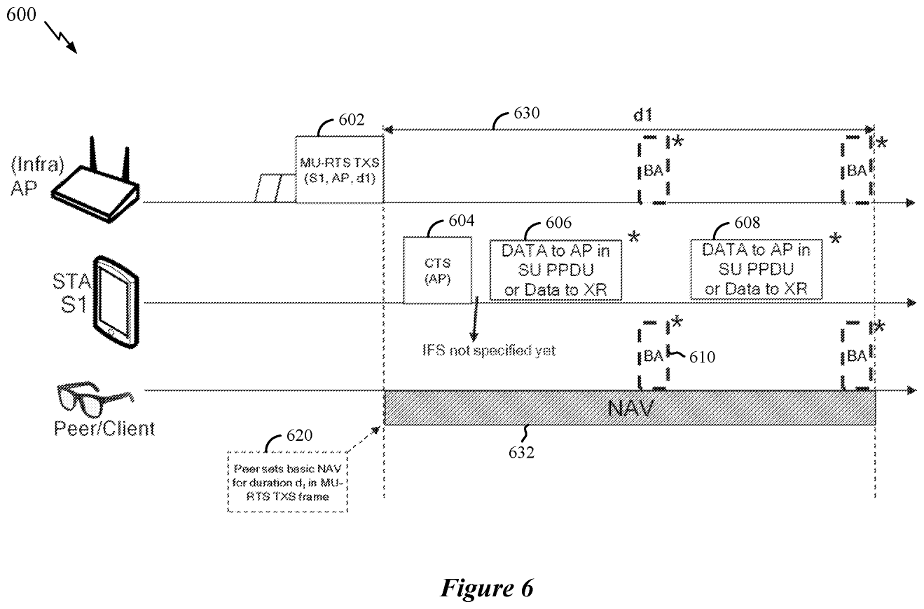

FIG. 6 shows an example of TXOP sharing. As illustrated, after successfully contending for access to the wireless medium and obtaining a TXOP, the AP may transmit a frame 602 to trigger sharing of the TXOP. Frame 602 may be what is referred to as a multi-user (MU) request to send (RTS) for TXOP sharing (TXS). Frame 602 may include a receive address (RA) set to a MAC address of STA S1, a transmit address (TA) set to a MAC address the AP and a duration field set to a value d1 to span to TXOP.

STA S1 may acknowledge the trigger frame 602 with a clear to send (CTS) frame 604, with an RA set to the MAC address of the AP. STA S1 may use the shared TXOP to transmit data to the AP and/or the peer, as shown at 606 and 608. There are various types of TXOP sharing Modes for which aspects of the present disclosure may be utilized. In some cases, a particular TXOP sharing mode may be indicated by a subfield value. For example, a first mode (Mode 1) generally refer to a mode in which an MU-RTS initiates an MU-RTS TXOP sharing procedure in which a scheduled STA may only transmit physical layer protocol data unit(s) (PPDU(s)) addressed to its associated AP. A second mode (Mode 2) generally refers to a mode in which an MU-RTS that initiates an MU-RTS TXOP sharing procedure in which a scheduled STA may transmit PPDU(s) addressed to its associated AP or addressed to another STA.

In certain systems, there may be two types of NAVs, an intra-BSS NAV for all frames within a basic service set (BSS), and a basic NAV for overlapping BSS (OBSS) frames (often called inter-BSS frames). A STA may set an intra-BSS NAV timer when it classifies the detected/received frames as Intra-BSS PPDUs (e.g., frames that match the STA's BSS color or frames with a BSSID field that matches the STA's associated AP). A STA sets a basic NAV timer when it detects OBSS frames with a different BSS color, frames with no BSS color in the case of legacy frames, or frames with a BSSID field that doesn't match the STA's associated AP.

As indicated at 620, the peer may set its basic NAV 632 for the duration d1 indicated in the trigger frame 602. As illustrated, during the basic NAV, the peer may be limited to sending block acknowledgments (BAs) 610, but is not allowed to transmit.

Certain devices (e.g., pre-802.11 ax devices) may just use one NAV where as other devices (e.g., 802.11ax and beyond devices) may use Intra-BSS and basic NAV. In addition to basic and intra-BSS NAV, other NAV types may also be defined. For example, one or more other NAV types may be defined in ultra-high reliability (UHR) systems between STAs that support such a capability and those STAs may set a new NAV (e.g., coordinating BSS NAV). This capability may cover the CTS to TXOP shared STA transmission (as described below), as well as TXOP return as part of TXOP Sharing capabilities.

### Enhanced Scheduling for TXOP Sharing

Aspects of the present disclosure, however, propose solutions that may be considered enhancements for TXOP sharing scenarios and may help address these potential challenges.

As described above, there are potential challenges for NAV allocation during a shared TXOP. One potential challenge is how to set a NAV to an optimal duration for certain traffic needs. For example, if a NAV is set to a duration that is too long during a shared TXOP (e.g., for the entire duration of the shared TXOP), uplink traffic from another device associated with the shared TXOP STA and another device (e.g., traffic from an XR headset to a phone) may be suppressed, impacting performance and user experience.

This issue may arise because an AP may not know a NAV requirement of a STA for a shared TXOP request. For example, when the AP allocates a shared TXOP to a client, the AP (e.g., in accordance with 802.11be wireless communication standards) may set the NAV of the TXOP to either of (1) a long NAV duration that covers the whole shared TXOP duration or (2) a short NAV duration.

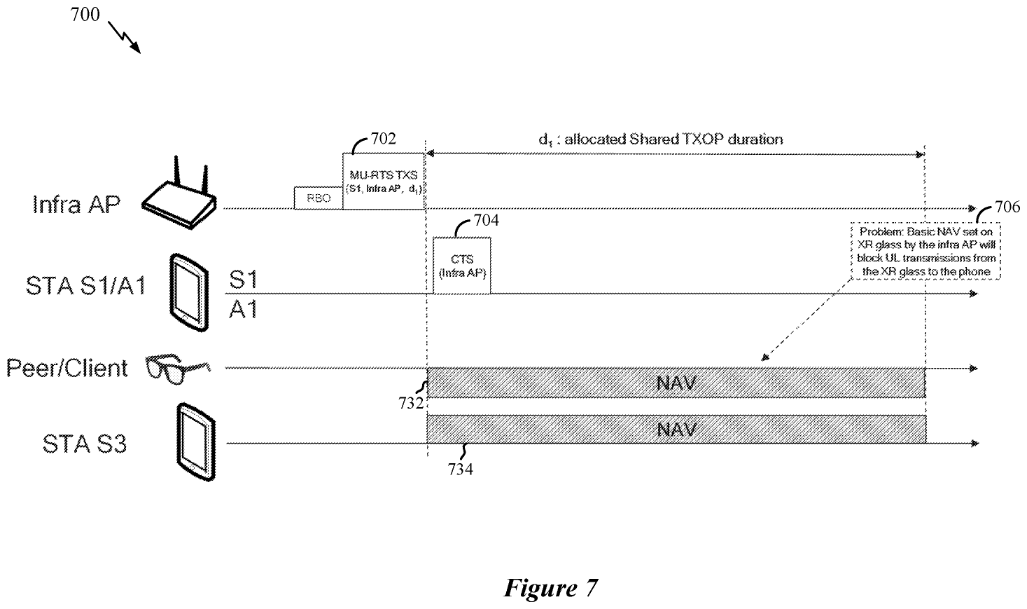

FIG. 7 shows an example of TXOP sharing with a long NAV duration. As illustrated, after successfully contending for access (e.g., after a random backoff-RBO) to the wireless medium and obtaining a TXOP, the AP may transmit a frame 702 (e.g., MU-RTS-TXS) to trigger sharing of the TXOP. S1 may acknowledge the trigger frame 702 with a CTS frame 704.

In the illustrated example, frame 702 has an RA set to a MAC address of STA S1, a TA set to a MAC address the AP, and a duration field set to a value d1 for a long duration, to span to duration of the shared TXOP. As indicated at 732 and 734, the peer and another STA S3 may set their basic NAVs accordingly.

Unfortunately, as indicated at 706, with the basic NAV set, the peer device (e.g., a headset or XR glass) cannot ignore the NAV, for example, when STA S1 (e.g., a phone) attempts to trigger uplink transmissions. As a result, uplink traffic from the peer may be suppressed during the shared TXOP, impacting performance and user experience.

Had the AP indicated a shorter NAV duration, when triggering the shared TXOP, the client STA S1 may have been able to participate in P2P communications with the peer (e.g., phone to XR glass), including uplink transmissions from the peer back to STA S1 (e.g., phone to XR glass).

Certain aspects of the present disclosure provide a signaling mechanism where a STA may indicate (e.g., to a potential TXOP sharing AP) a particular (desired/preferred) NAV setting for a shared TXOP. For example, the STA may request a short NAV setting if it wishes to conduct peer-to-peer (P2P) communications during the shared TXOP. Once the shorter NAV duration expires, the shared TXOP STA may trigger uplink traffic from a peer, in a remaining portion of the shared TXOP

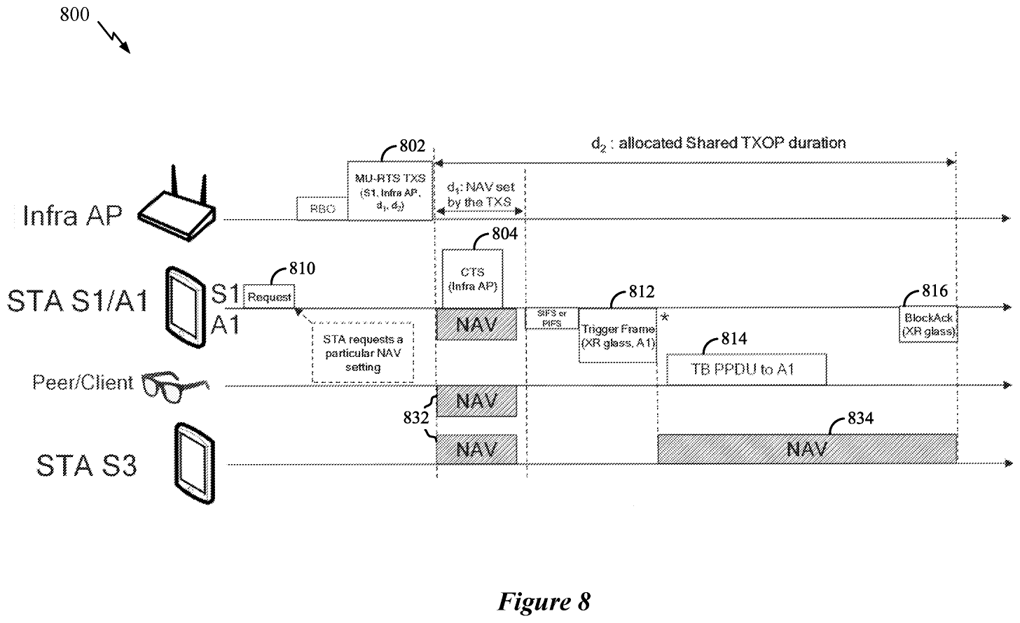

FIG. 8 shows a timing diagram illustrating an example 800 of TXOP sharing where a STA may indicate a particular NAV setting, in accordance with certain aspects of the present disclosure.

As shown at 810, STA S1 may send a frame 810 to the AP to indicate/request a particular NAV setting. As will be described in greater detail below, the request may indicate a certain type of NAV setting (e.g., selecting from one or more long durations and one or more short durations) or may indicate a particular duration value.

The illustrated example assumes that STA S1 has requested, via request 810, a short NAV duration. Thus, based on the request, the AP triggers a shared TXOP with a trigger frame 802 having d1 set to a duration substantially shorter than d2, the duration of the shared TXOP.

STA S1 may acknowledge the trigger frame 802 with a CTS frame 804. As indicated at 832, the peer and STA S3 set their NAV to the short duration d1. In some cases, STA S1 may serve the peer, for example, utilizing a software based AP (soft-AP) function, where the STA acts as an AP, with FIG. 8 using the designation STA A1 for the STA S1 acting in this capacity.

After the (short) NAV expires, STA A1 may trigger uplink transmission from the peer, via a trigger frame 812. As illustrated at 834, the trigger frame 812 may cause STA S3 to set its NAV for a remaining portion of the shared TXOP, thereby protecting uplink transmissions (e.g., TB PPDU 814) from the peer to STA A1. As illustrated, STA A1 may acknowledge the uplink transmissions, via a BA 816.

In this manner, aspects of the present disclosure may enable the AP to allocate the NAV that is best for a client operation during a shared TXOP. In some cases, a STA may request a particular NAV setting for a shared TXOP when requesting a shared TXOP allocation.

The particular NAV requested may depend on a particular objective or scenario. For example, the STA may request long NAV protection if it intends to use the shared TXOP (e.g., only) for DL transmissions to the other peer STA. On the other hand, as in the example shown in FIG. 8, the STA may request short NAV protection (e.g., up to clear-to-send (CTS) or more) to enable UL transmissions from the other peer along with the DL and/or necessary control frame transmissions. In certain aspects, the STA may request an exact NAV duration to be set (e.g., in a Duration/ID field) by the AP in the TXS frame.

In some aspects, the STA may indicate the NAV settings dynamically, using a one time request, for example, in a frame header. The frame header can be a medium access control (MAC) frame header and PHY header/preamble. In the case of a MAC frame header the indication may be in the HE-variant HT control field (A-control subfield). In this manner, the STA may provide an aperiodic indication of a preferred NAV setting for a single (e.g., next) allocation or subsequent allocations (e.g., overriding a periodic request or adding to a periodic request until explicitly changed). In some aspects, the STA may indicate the NAV settings for a periodic allocation (e.g., using a management frame such as stream classification service (SCS) Request frame).

Another potential challenge is how to ensure that a STA, outside the range of a shared TXOP recipient, sets its NAV appropriately. For example, because the STA is outside the range, it may not receive the CTS from the shared TXOP STA and may, thus, ignore the NAV and transmit potentially interrupting the shared TXOP.

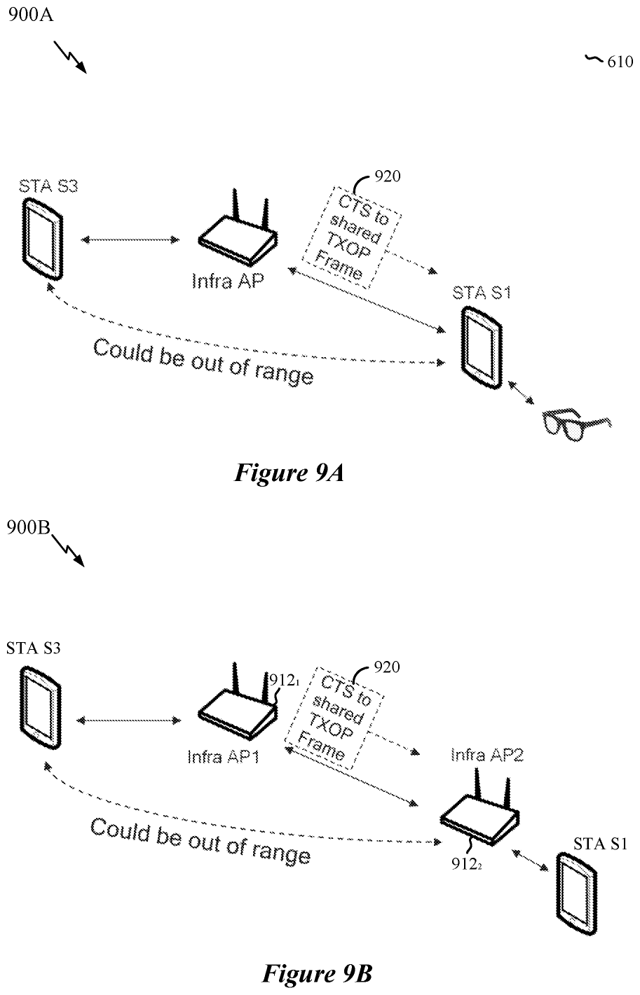

This potential challenge may be understood with reference to the scenario 900A illustrated in FIG. 9A. In the illustrated example, STA S3 may be out of range of STA S1. Thus, STA S4 may not hear/detect a CTS response sent by STA S1 after receiving a (MU RTS TXS) trigger frame from the AP. As a result, after a NAV timeout, STA S3 may contend for channel access and may transmit to the AP, which may result in collision with UL transmissions from STA S1 back to the AP and may interrupt the sequence within or after the shared TXOP (e.g., if additional p2p transmissions beyond the shared TXOP are intended).

Aspects of the present disclosure provide a special frame that may help address this challenge. This frame may be designed to allow a peer device to transmit to the shared TXOP STA during the shared TXOP, while protecting such transmissions. For example, this frame may help ensure NAV setting at the (AP or non-AP) STA that is out of range of the shared TXOP STA to prevent transmissions therefrom during the shared TXOP.

For example, this frame may have an address associated with the shared STA resulting in setting a first type of NAV (e.g., an intra-BSS or new type of NAV) for the peer device, while setting a second type of NAV (e.g., a basic NAV) at the out of range STA to prevent transmissions therefrom during the shared TXOP.

In some cases, such a frame may be a separate frame transmitted by the AP that is designed to set the Intra-BSS NAV (or new type of NAV) for a peer device of a shared TXOP recipient, while setting the Basic NAV for other STAs-so those STAs will not clear the NAV after NAV timeout, since this frame alone may be sufficient to set the Basic NAV.

As illustrated at 920 in FIG. 9A, such a frame may be transmitted from the AP, with the frame designed to (1) set the Intra-BSS NAV at the other peer/associated STA with TXOP shared STA and (2) cause a legacy STA to not clear its NAV after a NAV timeout, since this frame alone may be sufficient to set the NAV. In some cases, the frame may be a CTS frame, with its RA set to a MAC address associated with the shared TXOP STA. Thus, the frame may be referred to as a CTS-to-shared-TXOP-STA (or CTS-to-STA) frame. In this case, the STA can be an AP or non-AP STA and may be able to forward data frames and share TXOPs. In some cases, the data frame can carry an identifier (e.g., AID) of the sender or destination STA instead of just the transmitter and/or the receiving STAs identifiers. Such an ID may be carried in the frame header (which can be MAC or PHY). In some cases, the ID may be carried in the HT Control field (e.g., in the A-control subfield). This may help identify to which STA the frame is to be transmitted (e.g., including a requirement to do that in the shared TXOP, for example, based on some rules and signaling that may be defined).

Such a frame may also be used to benefit in the scenario 900B illustrated in FIG. 9B, where two APs, AP1 9121 and AP2 9122, may communicate to coordinate in an effort to support ultra-high reliability (UHR) traffic via multi-AP coordination. In this case, STA S3 may be out of range of AP2 9122 and, thus, may not hear/detect a CTS response. This case may apply to coordinated or cluster based time division multiple access (C-TDMA) scenarios. Thus, the AP1 may transmit a CTS-to-shared-TXOP frame to ensure STA S3 does not clear its NAV in the event that it does not hear a CTS from AP2 acknowledging the shared TXOP trigger frame.

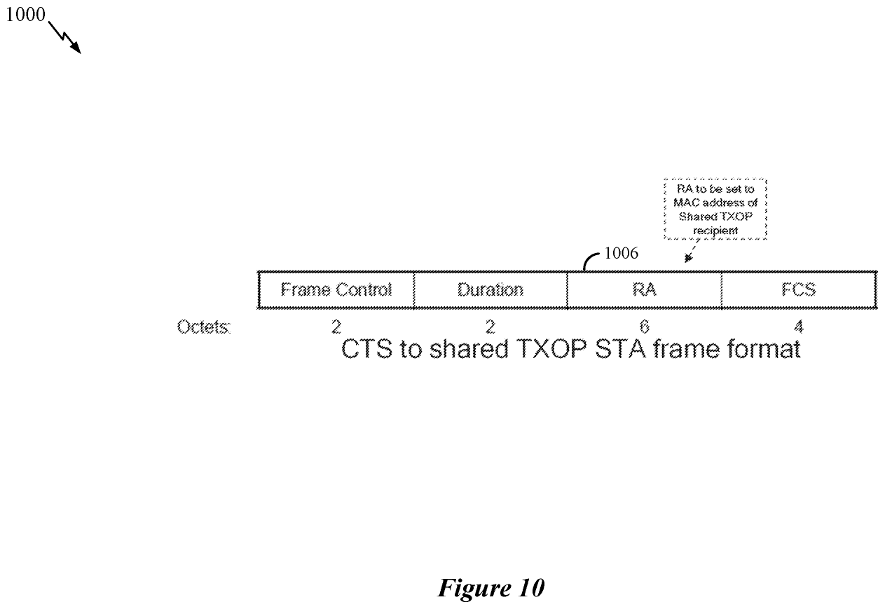

The CTS-to-shared-TXOP (or CTS-to-STA) frame proposed herein may help avoid the NAV timeout at a hidden STA that does not hear the CTS frame after the MU RTS TXS frame. As shown in FIG. 10, the CTS-to-TXOP-shared-STA may be a CTS frame 1000 whose RA field 1006 is set to an address associated with the STA that is associated with the STA receiving the shared TXOP. This address may be the MAC address of the shared TXOP STA. In some cases, the STA may be associated with a group or set, such as a multi-BSSID (MBSSID) set or Cohosted set, and the RA of the CTS-to-TXOP-shared-STA frame may be set to a MAC address that is part of the set.

In general, a peer STA, based on the RA address in a CTS-to-TXOP-shared-STA frame may be able to transmit in the UL. One approach is to explicitly have a rule to ignore the NAV (if treating it as basic NAV or define a new type of NAV), or to treat it as Intra-BSS NAV. For example, a NAV exception could be provided to some STAs (e.g., UHR/802.11bn STAs). Such an exception may allow such STAs to ignore the NAV based on an indication in a frame (e.g., a collective address or some other fields in the MAC frame header or the PHY header), may set the NAV based on some indication as mentioned as intra BSS NAV in which case the STA can ignore the NAV when triggered by its associated AP based current rules, and/or may set a new NAV type that can be ignored when a STA gets triggered from associated AP or coordinating APs. The coordinating APs for which the STA can ignore the NAV can be communicated to the STA (e.g., via management frames, such as a beacon frame or via control frame(s) that indicate the information (e.g., AID or MAC address) that the STA can detect to perform these actions related to the NAV).

In some cases, the address that results in a peer STA being able to transmit in the uplink may be communicated, for example, from the AP to STAs. For example, through management frames, the AP may inform the client (e.g., by including element in a Beacon or other frames used by AP coordination protocol (Coordinated Medium Access, coordinated (R)TWT, Coordinated TDMA, or the like).

In some cases, a special frame (such as a CTS-to-TXOP-shared-STA frame, a scheduling frame, or another type of existing or new frame) may include scheduling information for at least the shared TXOP STA. At least the shared TXOP STA may determine when to transmit and/or defer channel access, based on the scheduling information. Another STA (e.g., a STA that may be in range of the TXOP sharing AP and/or shared APs/STA or that may be out-of-range of the TXOP sharing AP and/or TXOP shared STA) may determine when to defer channel access, based on the scheduling information. The scheduling information may also indicate a total duration of the shared TXOP. The scheduling information may also indicate a minimum duration for each of the wireless nodes (e.g., shared TXOP STA, a peer of the shared TXOP STA, and/or another STA) to which the first wireless node intends to share the TXOP.

Different aspects of the present disclosure may be used during a service period (e.g., a TWT SP) or coordinated medium access period that is coordinated between different APs and/or STAs (e.g., Coordinated TWT such as Coordinated I-TWT, Coordinated B-TWT, Coordinated R-TWT, p2p TWT or any type of Coordinated TWT). In some cases, the transmitting STA (AP or non-AP) may transmit a scheduling frame or other frames, such as control frames (E.g., trigger frame such as MU RTS TXS Trigger frame), before a particular timestamp, such as SP start time (e.g., Coordinated Medium Access timestamp or period or TWT SP) to provide better protection for the transmission during the SP.

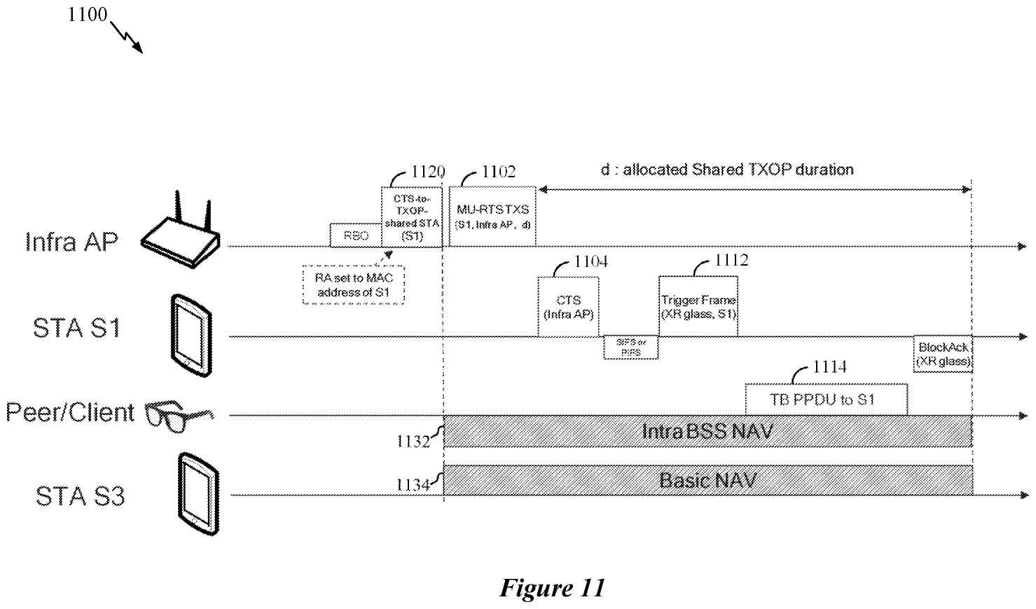

The various functionality achieved by a special frame, such as a CTS-to-TXOP-shared-STA frame, may be understood with reference to the example timelines 1100 shown in FIG. 11.

In the illustrated example, the (infrastructure) AP transmits a CTS-to-TXOP-shared-STA frame 1120 before a MU RTS TXS frame 1102 (or any other frame or frames, e.g., other frames that can be used for TXOP sharing). As illustrated, the CTS-to-TXOP-shared-STA frame may set the NAV 1134 at the hidden (legacy) STAs, such as STA S3), thereby avoiding the NAV timeout issue described above (e.g., in the event STA S3 did not hear CTS 1104 sent by shared TXOP STA S1).

The CTS-to-TXOP-shared-STA frame may also allow UL transmissions within the shared TXOP (e.g., from the other peer device or associated STA with a TXOP shared AP) since the Intra-BSS NAV 1132 may be set at the other peer/associated STA. Hence, when that peer is triggered (e.g., via trigger frame 1112), that peer is allowed to transmit UL data (TB PPDU 1114) based on the current Intra-BSS NAV rules. As noted above, a new type of NAV may also be defined, which can be set based on an ID of the other STA (e.g., MAC address/AID) or based on a group address.

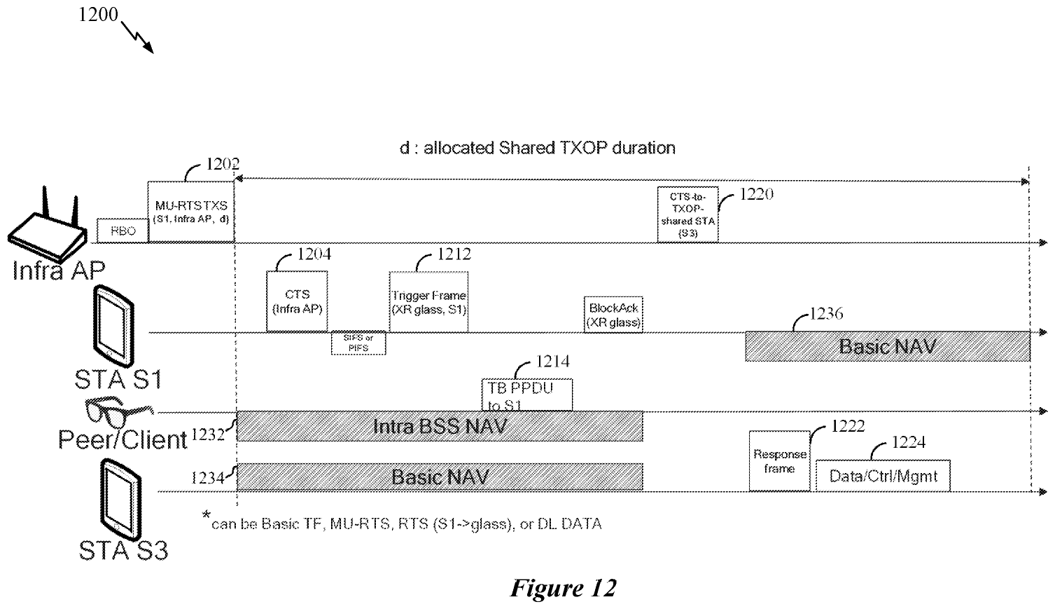

In the example timeline illustrated in FIG. 12, the (infrastructure) AP transmits a CTS-to-TXOP-shared-STA frame 1220 after a MU RTS TXS frame 1202.

The MU RTS TXS frame 1202 may trigger a shared TXOP duration and RA set to an address associated with STA S1. STA S1 may acknowledge the MU RTS TXS frame 1202 with a CTS 1204.

As illustrated, the MU RTS TXS frame 1202 may cause STA S3 to set its basic NAV 1234. In some cases, the peer may be configured to set its Intra-BSS NAV 1232 based on the MU RTS TXS frame 1202. Because of this, STA S1 may transmit a trigger frame 1212 to prompt uplink traffic (TB PPDU 1214) from the peer.

As illustrated, the AP may later transmit a CTS-to-TXOP-shared-STA frame 1220 with RA set to the MAC address of STA S3, which may cause STA S1 to set its basic NAV 1236. STA S3 may respond to the CTS-to-TXOP-shared-STA frame with a response frame 1222 and may subsequently transmit a (e.g., a data, control, or management) frame 1224.

As demonstrated by the examples described above, a CTS-to-TXOP-shared-STA frame may be used in various manners. In some cases, a CTS-to-TXOP-shared-STA frame may be used independently as an initiator frame for sharing the TXOP where the Duration field is set to the time (e.g., in ms), corresponding for the shared TXOP duration (to set the NAV at other STAs equal to this value). One option may be to require the receiving STA of the CTS-to-TXOP-shared-STA to send a CTS with RA address set to that receiving STA and the Duration field set to Duration field of the CTS-to-TXOP-shared-STA frame minus CTS frame transmission time minus SIFS duration. An alternative option may be to rely on detecting a transmission from the STA receiving the CTS-to-TXOP-shared-STA

As in the example shown in FIG. 11, a CTS-to-TXOP-shared-STA frame may also be used before the MU RTS TXS frame which is used for sharing the TXOP. If the CTS frame after the MU RTS TXS frame is not received successfully then the AP may send a CF-End also to clear the NAV set by the CTS-to-TXOP-shared-STA.

A CTS-to-TXOP-shared-STA frame (or other such frame) may be preceded by a short duration RTS/CTS frame exchange to ensure that the TXOP shared STA is ready for receiving the CTS-to-TXOP-shared-STA frame. As noted above, in some cases, the RA address may be set to a group address (e.g., an address known to a group of a STAs/APs) after which these STA can be allowed to transmit and ignore the NAV. In some cases, a shared TXOP (AP/non-AP) STA may indicate what the RA address should be set to (e.g., to the group address or an address associated with the group) In some cases, the indication may be via an identifier of the group or an identifier of one or more wireless nodes that belong to the group (e.g., an association ID/AID or another STA or AP ID).

A conventional CTS-to-self (where the RA is set to the MAC address of the transmitter) may not be able to achieve the same functionality (as the CTS-to-TXOP-shared-STA frame) since the CTS-to-self will carry the TXOP sharing AP MAC address and, hence, would set the basic NAV for the other peer/associated STA which will block UL transmissions.

The Intra-BSS NAV may be set at the peer/client based on the associated AP MAC address (e.g., of the STA S1 soft AP). When the peer STA receives the CTS-to-STA (CTS-to-TXOP-Shared-STA) frame, such frame may only carry the MAC address in the RA field. In this case, peer STA (e.g., an associated STA with the TXOP shared AP or another AP/non-AP STA) that receives such a frame may set the Intra BSS NAV if it classifies the PPDU as Intra BSS PPDU or other PPDU types (e.g., if the MAC address is the same as its associated AP MAC address or based on new rules). On the other hand, a STA will set the basic NAV if it sees a MAC address other than the associated AP MAC address or the other peer MAC address (e.g., STA S3 sets basic NAV as shown at 1134).

In case of an MU RTS trigger frame or other frames that carry both Transmitter Address (TA) and Receiver Address (RA), another STA that receive such frame will set the NAV based on the transmitter MAC address (TA or Address 2) in the MAC frame header.

Thus, the CTS-to-TXOP-Shared-STA frame proposed herein may be used to set the Intra BSS NAV instead of the basic NAV on the other peer/associated STA of another TXOP shared AP (e.g., STA S1 soft AP), so that the peer STA can respond with UL transmissions to Trigger frame which is not allowed if the basic NAV is set. Some special addresses may be used to trigger an Intra BSS NAV (or a new type of NAV) and, hence, allow UHR STAs to respond to UL while other (e.g., legacy) STAs are suppressed by the NAV.

In some cases, the AP may determine whether the CTS-to-TXOP-shared frame was successfully received, by the shared TXOP STA, and take one or more actions depending on the determination. For example, the AP may decide to release or return some/all of a shared TXOP if it determines the shared TXOP STA did not successfully receive the CTS-to-TXOP-shared frame.

The TXOP sharing AP may determine that the CTS-to-TXOP-shared-STA frame is successful if the AP detects a transmission within CTS/ACK Timeout following legacy rules of failure recovery. This timeout may be designed to provide enough time for an AP to detect a transmission which could be the time needed to detect the presence of PPDU in the air (at least a portion of the PHY header).

In other cases, the TXOP sharing AP may determine that the CTS-to-TXOP-Shared-STA is not successful based on an explicit response frame (e.g., it could be another CTS (CTS-to-self) frame or ACK/NACK frame). If the AP determines that the CTS-to-TXOP-shared-STA frame is not successful, the AP may send a CF-End to reset the NAV set by the CTS-to-TXOP-shared STA frame or the AP may send DL traffic to another STA within its BSS or to another AP. In some cases, if the CTS-to-TXOP-shared-STA frame is successful, then the TXOP shared STA may send a CF-End to reset the NAV set by the CTS-to-TXOP-shared STA frame if its ends transmission early (within a shared TXOP duration).

When transmitted by a TXOP shared STA/AP (which may be considered a TXOP leaser), the CF-End frame may act as an early return of the shared TXOP. After receiving such a CF-End frame from the TXOP shared STA/AP, the TXOP sharing AP may transmit. In some cases, the TXOP sharing AP may transmit within a short duration (e.g., SIFS or PIFS), so that it has more priority over other STAs. In other cases, the TXOP sharing AP may perform a random backoff (RBO) before transmitting again.

In some cases, a CF-End frame may act as a release back to the network where the TXOP sharing AP may have to contend again for channel access before transmitting any frame. In such cases, the CF-End frame may reset the NAV set at the other STAs receiving the CF-End frame. In some cases, the NAV may be an intra-BSS NAV, Basic (inter-BSS) NAV, or any other potential (new) NAV type set at those STAs.

In some cases, a CF-End frame may be transmitted by a TXOP sharing AP. When transmitted by a TXOP sharing STA/AP, the CF-End frame may act as TXOP release back to the network, where the TXOP sharing AP may have to contend again for channel access before transmitting any frame.

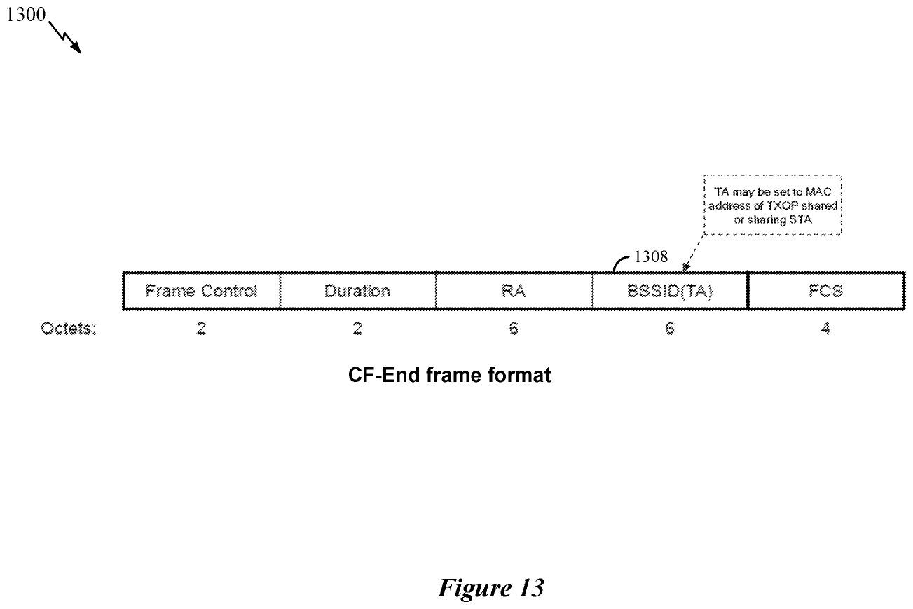

In some cases, as illustrated in the example frame 1300 of FIG. 13, the sharing may indicate a release or return of a shared TXOP by setting the BSSID (TA) field 1308 (or some such field) of the CF-End frame to either the TXOP Shared STA or the TXOP Sharing STA. In some cases, when transmitted by a certain type of station (e.g., a non-DMG and non-SIG STA), the Duration field may be set to 0. In some cases, when transmitted by a certain type of STA (e.g., a non-DMG STA), the RA field may be the broadcast address.

In some cases, a different type of frame (other than a CF-End frame, which may be new or existing) may be used to indicate a return or release of a shared TXOP. For example, in some cases, the MAC header of a frame (QOS Data/Null frame) may carry an indication of a TXOP return or an indication of maintaining the shared TXOP by the TXOP Shared STA/AP (TXOP leaser). Similar functionality may be achieved, when such a frame is transmitted by a TXOP sharing STA/AP.

In some cases, a TXOP shared STA/AP may return the unused time of a shared TXOP to a TXOP sharing AP by sending CTS frame that carries an indication to return the TXOP. In such cases, the return may be indicated via a special address in the RA field of the CTS frame and/or special duration field. For example, in some cases, the duration field can be set to 0 as an indication of a returned TXOP. In other cases, the duration field may be set to a predefined value or any possible value. In some cases, the RA field of the CTS frame may carry the address of the TXOP Sharing AP or TXOP shared AP. Such frame may be referred to as CTS-to-STA, CTS-to-AP, or CTS-to-TXOP-Sharing-AP frames.

In some cases, a TXOP shared AP may send a management frame to the TXOP sharing AP to return the unused medium time of the Shared TXOP. One advantage of this approach may be that, if it is immediately acknowledged, it may result in a reliable return of unused time in a shared TXOP. In some cases, a response (ACK) may not be required.

In some cases, a CTS (e.g., a CTS-to-AP or CTS-to-STA) frame (e.g., for duration 0) may be followed by a response frame to confirm the receipt of the TXOP return to the TXOP sharing AP. The response frame can be, for example, a CTS-to-Self frame by the TXOP sharing AP (which may also have a duration 0 or possibly another non-zero duration). In some cases, the response frame can be an ACK frame.

For coordinated AP transmissions, an MU RTS TXS allocation frame (or any other scheduling frame that in some cases may include a schedule) may be transmitted first to allocate resources to the APs. In such cases, a CTS-to-TXOP-shared-STA frame may then be transmitted to the TXOP shared AP, for example, when it is time to share the TXOP with that AP.

In some cases, a STA may also indicate the MAC address to which it wants the AP to set in the RA of the CTS-to-TXOP-shared-STA (or some other type of frame) which can be helpful for certain use cases (e.g., such as Wi-Fi Direct).

The signaling mechanisms proposed herein may allow a peer STA (e.g., an XR headset/glasses). In some cases, the peer may be served by the non-AP STA, via a soft AP instance. This may present a challenge, in that on the client device, the MAC address of the non-AP STA instance and the (soft) AP instance may be different (e.g., as indicated by the S1 and A1 labels shown in FIG. 8). The (infrastructure) AP may not be aware of the MAC address of the SoftAP instance and the peer STA (i.e., glass) may not be aware of the MAC address of the non-AP STA instance associated with the AP. If the AP transmits a CTS-to-STA with the RA set to the MAC address of the non-AP STA instance, the peer STA may not set the intra-BSS NAV in such case, since the non-AP STA instance appears as an OBSS. Aspects of the present disclosure may help address this challenge in various ways. For example, the SoftAP may advertise its BSS as part of a co-hosted or multi-BSS set, with an ‘n’ value selected such that the two addresses falls in the range of the set. An MBSSID IE does not need to include any non-transmitting (non-Tx) BSSID profile, since the non-AP STA instance is not a virtual AP (VAP). Certain standards (e.g., 8022.11ax) may have rules that require that an intra-BSS NAV is set for any transmission within the same set. One benefit to this scheme is that it may seamlessly work without the infra AP or the peer STA needing to know the MAC address of the SoftAP or the non-AP STA instance, respectively, on the client device.

In some cases, a (peer) STA receiving such an address in a CTS-to-STA may be able to transmit in the UL. One approach to accomplish this is to have a rule that the STA is to ignore the NAV in this case. Another approach is to define a new type of NAV, while yet another approach is to set an Intra-BSS NAV.

When AP sends the TXS with mode 2, the AP may allocate a shared TXOP for both UL and P2P. However, in some cases, based on requested resources or resource constraints, the AP may want to control the allocation time for either UL or p2p only. Aspects of the present disclosure provide various mechanisms for this. For example, with a NAV based mechanism, the AP may control the usage of the shared TXOP by setting a long NAV to cover the duration during which the TXOP shared STA can use the NAV either for UL or DL without p2p. The AP may set a shorter NAV in the remaining part of the TXOP to enable UL/DL transmissions between the peer-to-peer STAs.

As another example, with a NAV based mechanism, the AP may use a CTS-to-Self frame so that the TXOP shared STA can use the allocated duration either for UL or DL without P2P. The AP may use the CTS-to-TXOP-shared-STA so that the TXOP shared STA can use the allocated duration mainly for P2P.

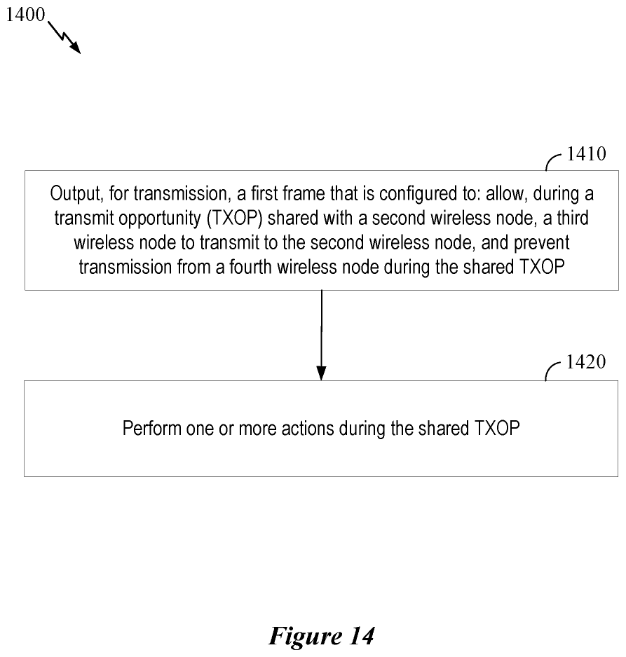

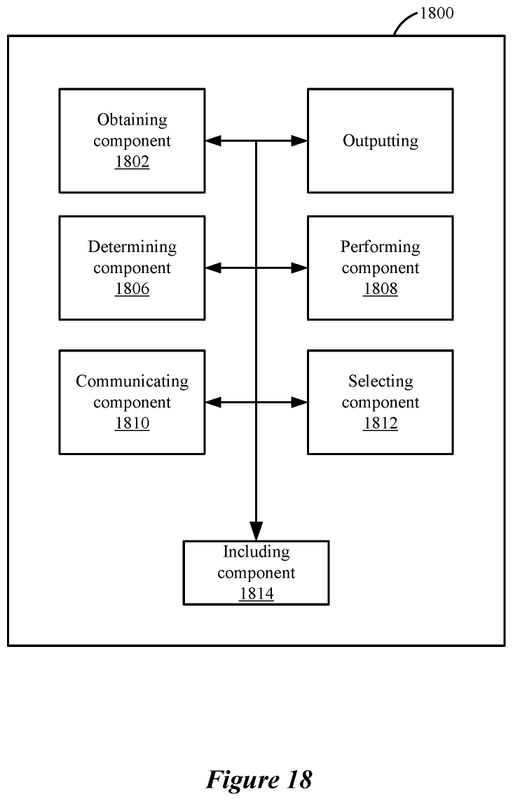

FIG. 14 shows a flowchart illustrating a process 1400 performable at a first wireless node, according to some aspects of the present disclosure. The operations of the process 1400 may be implemented by the first wireless node or its components as described herein. For example, the process 1400 may be performed by a wireless communication device, such as a wireless communication device 1800 described with reference to FIG. 18, operating as or within the first wireless node. In some examples, the process 1400 may be performed by the first wireless node, such as one of the wireless APs 102 or STAs 104 described with reference to FIG. 1. The operations of the process 1400 and subject matter of the present disclosure may be applicable for different systems. For example, the operations of the process 1400 and the subject matter of the present disclosure may apply to 802.11s mesh system (as defined in Institute of Electrical and Electronics Engineers (IEEE) 802.11), an easy mesh system (as defined in WiFi Alliance), and/or other mesh-based network systems.

At 1410, the process 1400 includes the first wireless node outputting, for transmission, a first frame that is configured to: allow, during a transmit opportunity (TXOP) shared with a second wireless node, a third wireless node to transmit to the second wireless node, and prevent transmission from a fourth wireless node during the shared TXOP.

At 1420, the process 1400 includes the first wireless node performing one or more actions during the shared TXOP.

In some aspects, the first frame is configured to at least one of: set a first network allocation vector (NAV) of a first type during the shared TXOP, wherein the first NAV allows the third wireless node to transmit to the second wireless node during the shared TXOP, or set a second NAV of a second type for the fourth wireless node, wherein the second NAV prevents transmission from the fourth wireless node during the shared TXOP.

In some aspects, the first frame includes scheduling information for at least the second wireless node.

In some aspects, the scheduling information indicates at least one of: when at least the second wireless node is allowed to transmit; or when at least the second wireless node is to defer channel access.

In some aspects, the scheduling information indicates when the fourth wireless node is to defer its channel access.

In some aspects, the scheduling information indicates a total duration of the shared TXOP.

In some aspects, the scheduling information indicates, for each of one or more wireless nodes including at least the second node, a minimum duration that the first wireless node intends to share the TXOP with that wireless node.

In some aspects, the first frame is also configured to trigger the shared TXOP.

In one aspect, method 1400, or any aspect related to it, may be performed by an apparatus, such as wireless communication device 1800 of FIG. 18, which includes various components operable, configured, or adapted to perform the method 1400. Communications device 1100 is described below in further detail.

Note that FIG. 14 is just one example of a method, and other methods including fewer, additional, or alternative steps are possible consistent with this disclosure.

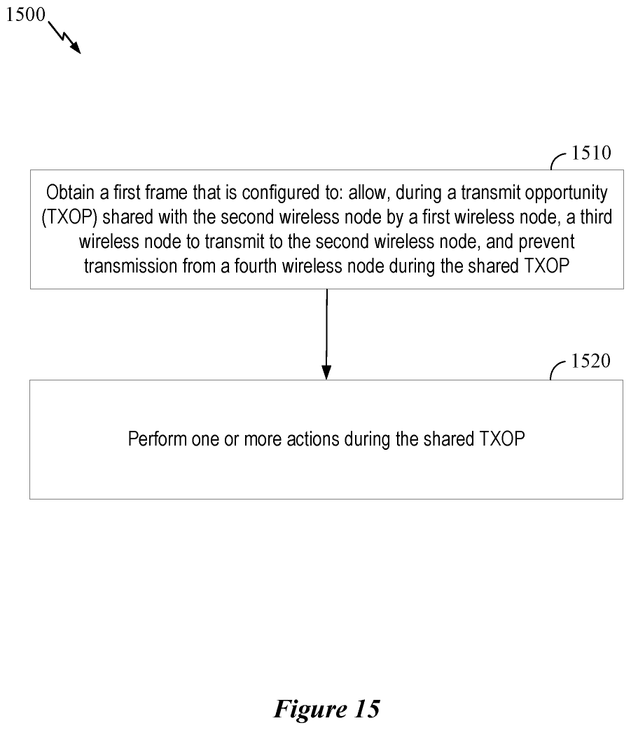

FIG. 15 shows a flowchart illustrating a process 1500 performable at a second wireless node, according to some aspects of the present disclosure. The operations of the process 1500 may be implemented by the first wireless node or its components as described herein. For example, the process 1500 may be performed by a wireless communication device, such as a wireless communication device 1800 described with reference to FIG. 18, operating as or within the first wireless node. In some examples, the process 1500 may be performed by the first wireless node, such as one of the wireless APs 102 or STAs 104 described with reference to FIG. 1. The operations of the process 1500 and subject matter of the present disclosure may be applicable for different systems. For example, the operations of the process 1500 and the subject matter of the present disclosure may apply to 802.11s mesh system (as defined in Institute of Electrical and Electronics Engineers (IEEE) 802.11), an easy mesh system (as defined in WiFi Alliance), and/or other mesh-based network systems.

At 1510, the process 1500 includes the second wireless node obtaining a first frame that is configured to: allow, during a transmit opportunity (TXOP) shared with the second wireless node by a first wireless node, a third wireless node to transmit to the second wireless node, and prevent transmission from a fourth wireless node during the shared TXOP.

At 1520, the process 1500 includes the second wireless node performing one or more actions during the shared TXOP.

In some aspects, the first frame includes scheduling information for at least the second wireless node that indicates at least one of: when at least the second wireless node is allowed to transmit; or when at least the second wireless node is to defer channel access.

In some aspects, the method 1500 further includes obtaining a second frame configured to trigger the shared TXOP. In some cases, the operations of this step refer to, or may be performed by, circuitry for obtaining and/or code for obtaining as described with reference to FIG. 18.

In some aspects, the first frame comprises a clear to send (CTS) frame.

In some aspects, the first frame has a first address set to an address associated with the second wireless node.

In some aspects, the first address comprises a receive address (RA) that is set to an address associated with a group to which the second wireless node belongs.

In some aspects, the one or more actions comprise at least one of: outputting at least a second frame indicating an early termination of the shared TXOP by the second wireless node; or obtaining at least a third frame configured to release or return at least a portion of the shared TXOP.

In one aspect, method 1500, or any aspect related to it, may be performed by an apparatus, such as wireless communication device 1800 of FIG. 18, which includes various components operable, configured, or adapted to perform the method 1500. Communications device 1100 is described below in further detail.

Note that FIG. 15 is just one example of a method, and other methods including fewer, additional, or alternative steps are possible consistent with this disclosure.

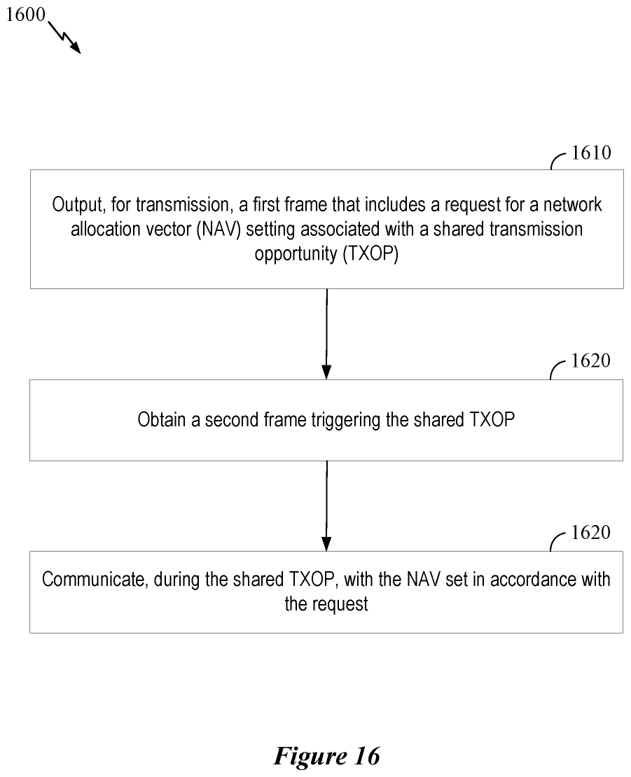

FIG. 16 shows a flowchart illustrating a process 1600 performable at a wireless node, according to some aspects of the present disclosure. The operations of the process 1600 may be implemented by the first wireless node or its components as described herein. For example, the process 1600 may be performed by a wireless communication device, such as a wireless communication device 1800 described with reference to FIG. 18, operating as or within the first wireless node. In some examples, the process 1600 may be performed by the first wireless node, such as one of the wireless APs 102 or STAs 104 described with reference to FIG. 1. The operations of the process 1600 and subject matter of the present disclosure may be applicable for different systems. For example, the operations of the process 1600 and the subject matter of the present disclosure may apply to 802.11s mesh system (as defined in Institute of Electrical and Electronics Engineers (IEEE) 802.11), an easy mesh system (as defined in WiFi Alliance), and/or other mesh-based network systems.

At 1610, the process 1600 includes the wireless node outputting, for transmission, a first frame that includes a request for a network allocation vector (NAV) setting associated with a shared transmission opportunity (TXOP).

At 1620, the process 1600 includes the wireless node obtaining a second frame triggering the shared TXOP.

At 1630, the process 1600 includes the wireless node communicating, during the shared TXOP, with the NAV set in accordance with the request.

In some aspects, at least a first duration of the different durations corresponds to a duration of the shared TXOP.

In some aspects, the selected NAV setting has a second duration that is shorter than a first duration; and the method further comprises obtaining one or more signals after expiration of a NAV set according to the second duration.

In some aspects, the request includes a field that indicates a duration for the NAV setting.

In some aspects, the first frame includes a request for the shared TXOP.

In some aspects, the request is for: the NAV setting to be applied for just the shared TXOP; or the NAV setting to be applied for a periodic allocation of shared TXOPs.

In one aspect, method 1600, or any aspect related to it, may be performed by an apparatus, such as wireless communication device 1800 of FIG. 18, which includes various components operable, configured, or adapted to perform the method 1600. Communications device 1100 is described below in further detail.

Note that FIG. 16 is just one example of a method, and other methods including fewer, additional, or alternative steps are possible consistent with this disclosure.

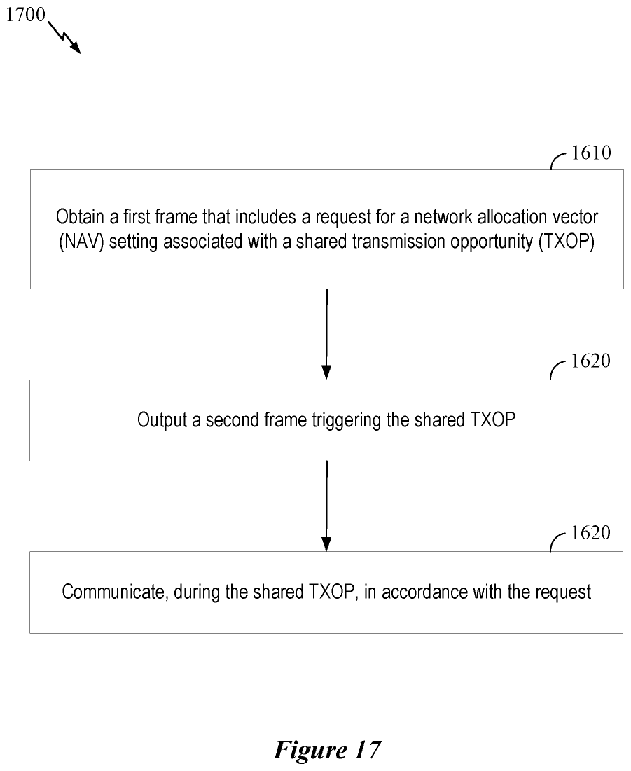

FIG. 17 shows a flowchart illustrating a process 1700 performable at a wireless node, according to some aspects of the present disclosure. The operations of the process 1700 may be implemented by the first wireless node or its components as described herein. For example, the process 1700 may be performed by a wireless communication device, such as a wireless communication device 1800 described with reference to FIG. 18, operating as or within the first wireless node. In some examples, the process 1700 may be performed by the first wireless node, such as one of the wireless APs 102 or STAs 104 described with reference to FIG. 1. The operations of the process 1700 and subject matter of the present disclosure may be applicable for different systems. For example, the operations of the process 1700 and the subject matter of the present disclosure may apply to 802.11s mesh system (as defined in Institute of Electrical and Electronics Engineers (IEEE) 802.11), an easy mesh system (as defined in WiFi Alliance), and/or other mesh-based network systems.

At 1710, the process 1700 includes the wireless node obtaining a first frame that includes a request for a network allocation vector (NAV) setting associated with a shared transmission opportunity (TXOP).

At 1720, the process 1700 includes the wireless node outputting, for transmission, a second frame triggering the shared TXOP.

At 1730, the process 1700 includes the wireless node communicating, during the shared TXOP, in accordance with the request.

In some aspects, the request includes a field that indicates selection of the NAV setting, from a plurality of NAV settings having different durations.

In some aspects, at least a first duration of the different durations corresponds to a duration of the shared TXOP.

In some aspects, the request includes a field that indicates a duration for the NAV setting.

In some aspects, the first frame includes a request for the shared TXOP.

In some aspects, the request is for: the NAV setting to be applied for just the shared TXOP; or the NAV setting to be applied for a periodic allocation of shared TXOPs.

In one aspect, method 1700, or any aspect related to it, may be performed by an apparatus, such as wireless communication device 1800 of FIG. 18, which includes various components operable, configured, or adapted to perform the method 1700. Communications device 1100 is described below in further detail.

Note that FIG. 17 is just one example of a method, and other methods including fewer, additional, or alternative steps are possible consistent with this disclosure.

FIG. 18 shows a block diagram of a wireless communication device 1800 (such as an AP or non-AP STA), according to some aspects of the present disclosure. In one example, the wireless communication device 1800 is configured or operable to perform a process 1400 described with reference to FIG. 14. In another example, the wireless communication device 1800 is configured or operable to perform a process 1500 described with reference to FIG. 15. In another example, the wireless communication device 1800 is configured or operable to perform a process 1600 described with reference to FIG. 16. In another example, the wireless communication device 1500 is configured or operable to perform a process 1700 described with reference to FIG. 17. In various examples, the wireless communication device 1800 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some examples, the wireless communication device 1800 can be a device for use in an AP, such as AP 102 described with reference to FIG. 1. In some other examples, the wireless communication device 1800 can be an AP that includes a chip, SoC, chipset, package or device as well as multiple antennas. The wireless communication device 1800 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 1800 also includes or can be coupled with an application processor which may be further coupled with another memory. In some examples, the wireless communication device 1800 further includes at least one external network interface that enables communication with a core network or backhaul network to gain access to external networks including the Internet.

The wireless communication device 1800 includes obtaining component 1802, outputting component 1804, determining component 1806, performing component 1808, communicating component 1810, selecting component 1812, and/or including component 1814.

Portions of one or more of the components 1802, 1804, 1806, 1808, 1810, 1812, and/or 1814 may be implemented at least in part in hardware or firmware. For example, the obtaining component 1802 and the outputting component 1804 may be implemented at least in part by a modem. In some examples, at least some of the components 1802, 1804, 1806, 1808, 1810, 1812, and/or 1814 are implemented at least in part by at least one processor and as software stored in a memory. For example, portions of one or more of the components 1802, 1804, 1806, 1808, 1810, 1812, and/or 1814 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the wireless communication device 1800). For example, a processing system of the wireless communication device 1800 may refer to a system including the various other components or subcomponents of the wireless communication device 1800, such as the processor, or a transceiver, or a communications manager, or other components or combinations of components of the wireless communication device 1800. The processing system of the wireless communication device 1800 may interface with other components of the wireless communication device 1800, and may process information received from other components (such as inputs or signals) or output information to other components. For example, a chip or modem of the wireless communication device 1800 may include a processing system, a first interface to output information and a second interface to obtain information. In some implementations, the first interface may refer to an interface between the processing system of the chip or modem and a transmitter, such that the wireless communication device 1800 may transmit information output from the chip or modem. In some implementations, the second interface may refer to an interface between the processing system of the chip or modem and a receiver, such that the wireless communication device 1800 may obtain information or signal inputs, and the information may be passed to the processing system. A person having ordinary skill in the art will readily recognize that the first interface also may obtain information or signal inputs, and the second interface also may output information or signal outputs.

Various components of the wireless communication device 1800 may provide means for performing the process 1400 described with reference to FIG. 14, the process 1500 described with reference to FIG. 15, the process 1600 described with reference to FIG. 16, the process 1700 described with reference to FIG. 17, or any aspect related to them. Means for receiving or obtaining may include transceivers and/or antenna(s) of the AP 102 described with reference to FIG. 1 and/or the obtaining component 1802 of the wireless communication device 1800. Means for transmitting, sending or outputting for transmission may include transceivers and/or antenna(s) of the AP 102 described with reference to FIG. 1 and/or the outputting component 1804 of the wireless communication device 1800.

Means for determining may include one or more processors (such as a receive processor, a controller, and/or a transmit processor) of the AP 102 described with reference to FIG. 1 and/or the determining component 1806 of the wireless communication device 1800. Means for performing may include one or more processors (such as a receive processor, a controller, and/or a transmit processor) of the AP 102 described with reference to FIG. 1 and/or the performing component 1808 of the wireless communication device 1800. Means for communicating may include one or more processors (such as a receive processor, a controller, and/or a transmit processor) of the AP 102 described with reference to FIG. 1 and/or the communicating component 1810 of the wireless communication device 1800. Means for selecting may include one or more processors (such as a receive processor, a controller, and/or a transmit processor) of the AP 102 described with reference to FIG. 1 and/or the selecting component 1812 of the wireless communication device 1800. Means for including may include one or more processors (such as a receive processor, a controller, and/or a transmit processor) of the AP 102 described with reference to FIG. 1 and/or the including component 1814 of the wireless communication device 1800.

In some cases, rather than actually transmitting, for example, signals and/or data, the wireless communication device 1100 may have an interface to output signals and/or data for transmission (means for outputting). For example, a processor may output signals and/or data, via a bus interface, to a radio frequency (RF) front end of the wireless communication device 1800 for transmission. In various aspects, the RF front end may include various components, including transmit and receive processors, transmit and receive MIMO processors, modulators, demodulators, and the like.

In some cases, rather than actually receiving signals and/or data, the wireless communication device 1800 may have an interface to obtain the signals and/or data received from another device (means for obtaining). For example, a processor may obtain (or receive) the signals and/or data, via a bus interface, from an RF front end of the wireless communication device 1800 for reception. In various aspects, the RF front end may include various components, including transmit and receive processors, transmit and receive MIMO processors, modulators, demodulators, and the like.

### Example Clauses

Implementation examples are described in the following numbered clauses:

Clause 1: A method for wireless communications at a first wireless node, comprising: outputting, for transmission, a first frame that is configured to: allow, during a transmit opportunity (TXOP) shared with a second wireless node, a third wireless node to transmit to the second wireless node, and prevent transmission from a fourth wireless node during the shared TXOP; and performing one or more actions during the shared TXOP.

Clause 2: The method of Clause 1, wherein the first frame is configured to at least one of: set a first network allocation vector (NAV) of a first type during the shared TXOP, wherein the first NAV allows the third wireless node to transmit to the second wireless node during the shared TXOP, or set a second NAV of a second type for the fourth wireless node, wherein the second NAV prevents transmission from the fourth wireless node during the shared TXOP.

Clause 3: The method of any one of Clauses 1-2, wherein the first frame includes scheduling information for at least the second wireless node.

Clause 4: The method of Clause 3, wherein the scheduling information indicates at least one of: when at least the second wireless node is allowed to transmit; or when at least the second wireless node is to defer channel access.

Clause 5: The method of Clause 3, wherein the scheduling information indicates when the fourth wireless node is to defer its channel access.

Clause 6: The method of Clause 3, wherein the scheduling information indicates a total duration of the shared TXOP.

Clause 7: The method of Clause 3, wherein the scheduling information indicates, for each of one or more wireless nodes including at least the second node, a minimum duration that the first wireless node intends to share the TXOP with that wireless node.

Clause 8: The method of any one of Clauses 1-7, wherein the first frame is also configured to trigger the shared TXOP.

Clause 9: The method of any one of Clauses 1-8, further comprising outputting, for transmission, a second frame configured to trigger the shared TXOP.

Clause 10: The method of Clause 9, wherein the first frame is output for transmission before the second frame.

Clause 11: The method of any one of Clauses 1-10, wherein the first frame comprises a clear to send (CTS) frame.

Clause 12: The method of any one of Clauses 1-11, further comprising determining whether the first frame was successfully received by the second wireless node, wherein the one or more actions depend on the determination.

Clause 13: The method of Clause 12, further comprising: obtaining a response frame from the second wireless node, wherein the determination of the first frame was successfully received by the second wireless is based on the response frame.

Clause 14: The method of Clause 13, wherein, if the determination indicates the first frame was not successfully received by the second wireless node, the one or more actions comprise outputting, for transmission, at least a third frame configured to at least one of: reset a first network allocation vector (NAV) set by the first frame, reset a second NAV set by the first frame, or convey data to another wireless node.

Clause 15: The method of any one of Clauses 1-14, wherein the first frame has a first address set to an address associated with the second wireless node.

Clause 16: The method of Clause 15, wherein the first address comprises a receive address (RA).

Clause 17: The method of Clause 16, wherein the RA is set to an address associated with a group to which the second wireless node belongs.

Clause 18: The method of Clause 17, further comprising outputting, for transmission, an indication of at least one of the address associated with the group or one or more identifiers of one or more wireless nodes that belong to the group.

Clause 19: The method of Clause 17, further comprising: obtaining a frame requesting an address to be used for setting an RA, wherein the RA of at least one of the first frame or a second frame is set to the requested address.

Clause 20: The method of any one of Clauses 1-19, wherein the one or more actions comprise obtaining at least a third frame indicating an early termination of the shared TXOP from the second wireless node.

Clause 21: The method of any one of Clauses 1-20, wherein the one or more actions comprise outputting, for transmission, at least a third frame configured to release or return at least a portion of the shared TXOP.

Clause 22: The method of Clause 21, wherein a header of the third frame includes an indication of the release or the return.

Clause 23: The method of any one of Clauses 1-22, wherein the first frame is further configured to at least one of: prevent communication between the second wireless node and the third wireless node during a portion of the shared TXOP; or allow communication between the second wireless node and the third wireless node during another portion of the shared TXOP.

Clause 24: A method for wireless communications at a second wireless node, comprising: outputting, for transmission, a first frame that is configured to: allow, during a transmit opportunity (TXOP) shared with the second wireless node by a first wireless node, a third wireless node to transmit to the second wireless node, and prevent transmission from a fourth wireless node during the shared TXOP; and performing one or more actions during the shared TXOP.

Clause 25: The method of Clause 24, wherein the first frame includes scheduling information for at least the second wireless node that indicates at least one of: when at least the second wireless node is allowed to transmit; or when at least the second wireless node is to defer channel access.

Clause 26: The method of any one of Clauses 24-25, further comprising obtaining a second frame configured to trigger the shared TXOP.

Clause 27: The method of any one of Clauses 24-26, wherein the first frame comprises a clear to send (CTS) frame.

Clause 28: The method of any one of Clauses 24-27, wherein the first frame has a first address set to an address associated with the second wireless node.

Clause 29: The method of Clause 28, wherein the first address comprises a receive address (RA) that is set to an address associated with a group to which the second wireless node belongs.

Clause 30: The method of any one of Clauses 24-29, wherein the one or more actions comprise at least one of: outputting at least a second frame indicating an early termination of the shared TXOP by the second wireless node; or obtaining at least a third frame configured to release or return at least a portion of the shared TXOP.

Clause 31: A method for wireless communications at a wireless node, comprising: outputting, for transmission, a first frame that includes a request for a network allocation vector (NAV) setting associated with a shared transmission opportunity (TXOP); obtaining a second frame triggering the shared TXOP; and communicating, during the shared TXOP, with the NAV set in accordance with the request.

Clause 32: The method of Clause 31, further comprising: selecting the NAV setting, from a plurality of NAV settings having different durations; and including, in the request, a field that indicates the selected NAV setting.

Clause 33: The method of Clause 32, wherein at least a first duration of the different durations corresponds to a duration of the shared TXOP.

Clause 34: The method of Clause 33, wherein: the selected NAV setting has a second duration that is shorter than a first duration; and the method further comprises obtaining one or more signals after expiration of a NAV set according to the second duration.

Clause 35: The method of any one of Clauses 31-34, wherein the request includes a field that indicates a duration for the NAV setting.

Clause 36: The method of any one of Clauses 31-35, wherein the first frame includes a request for the shared TXOP.

Clause 37: The method of any one of Clauses 31-36, wherein the request is for: the NAV setting to be applied for just the shared TXOP; or the NAV setting to be applied for a periodic allocation of shared TXOPs.

Clause 38: A method for wireless communications at a wireless node, comprising: obtaining a first frame that includes a request for a network allocation vector (NAV) setting associated with a shared transmission opportunity (TXOP); outputting a second frame triggering the shared TXOP; and communicating, during the shared TXOP, in accordance with the request.

Clause 39: The method of Clause 38, wherein the request includes a field that indicates selection of the NAV setting, from a plurality of NAV settings having different durations.

Clause 40: The method of Clause 39, wherein at least a first duration of the different durations corresponds to a duration of the shared TXOP.

Clause 41: The method of any one of Clauses 38-40, wherein the request includes a field that indicates a duration for the NAV setting.

Clause 42: The method of any one of Clauses 38-41, wherein the first frame includes a request for the shared TXOP.

Clause 43: The method of any one of Clauses 38-42, wherein the request is for: the NAV setting to be applied for just the shared TXOP; or the NAV setting to be applied for a periodic allocation of shared TXOPs.

Clause 44: An apparatus, comprising: a memory comprising executable instructions; and at least one processor configured to execute the executable instructions and cause the apparatus to perform a method in accordance with any one of Clauses 1-43.

Clause 45: An apparatus, comprising means for performing a method in accordance with any one of Clauses 1-43.

Clause 46: A non-transitory computer-readable medium comprising executable instructions that, when executed by at least one processor of an apparatus, cause the apparatus to perform a method in accordance with any one of Clauses 1-43.

Clause 47: A computer program product embodied on a computer-readable storage medium comprising code for performing a method in accordance with any one of Clauses 1-43.

Clause 48: An access point comprising: at least one transceiver, a memory comprising executable instructions; and a processor configured to execute the executable instructions and cause the access point to perform a method in accordance with any one of Clauses 1-23, wherein the at least one transceiver is configured to transmit the first frame.

Clause 49: A wireless station comprising: at least one transceiver, a memory comprising executable instructions; and a processor configured to execute the executable instructions and cause the wireless station to perform a method in accordance with any one of Clauses 24-30, wherein the at least one transceiver is configured to receive the first frame.

Clause 50: A wireless station comprising: at least one transceiver, a memory comprising executable instructions; and a processor configured to execute the executable instructions and cause the wireless station to perform a method in accordance with any one of Clauses 31-37, wherein the at least one transceiver is configured to at least one of transmit the first frame or receive the second frame.

Clause 51: An access point comprising: at least one transceiver, a memory comprising executable instructions; and a processor configured to execute the executable instructions and cause the access point to perform a method in accordance with any one of Clauses 38-43, wherein the at least one transceiver is configured to at least one of receive the first frame or transmit the second frame.

### ADDITIONAL CONSIDERATIONS

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on.” “associated with”, or “in accordance with” unless otherwise explicitly indicated. Specifically, unless a phrase refers to “based on only ‘a,”’ or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communications at a first wireless node, comprising:
at least one processor;
memory coupled with the processor; and
instructions stored in the memory and executable by the at least one processor to cause the apparatus to:
output, for transmission, a first frame that includes a request for a network allocation vector (NAV) setting associated with a shared transmission opportunity (TXOP);
obtain a second frame triggering the shared TXOP; and
communicate, during the shared TXOP, with the NAV set in accordance with the request.

2. The apparatus of claim 1, wherein the instructions stored in the memory and executable by the at least one processor further cause the apparatus to:
select the NAV setting, from a plurality of NAV settings having different durations; and
include, in the request, a field that indicates the selected NAV setting.

3. The apparatus of claim 2, wherein at least a first duration of the different durations corresponds to a duration of the shared TXOP.

4. The apparatus of claim 3, wherein:
the selected NAV setting has a second duration that is shorter than a first duration; and
the apparatus further comprises obtaining one or more signals after expiration of a NAV set according to the second duration.

5. The apparatus of claim 1, wherein the request includes a field that indicates a duration for the NAV setting.

6. The apparatus of claim 1, wherein the first frame includes a request for the shared TXOP.

7. The apparatus of claim 1, wherein the request is for:
the NAV setting to be applied for just the shared TXOP; or
the NAV setting to be applied for a periodic allocation of shared TXOPs.

8. The apparatus of claim 1, further comprising:
at least one transceiver configured to transmit the first frame, wherein the apparatus is configured as a wireless station.

9. An apparatus for wireless communications at a first wireless node, comprising:
at least one processor;
memory coupled with the processor; and
instructions stored in the memory and executable by the at least one processor to cause the apparatus to:
obtain a first frame that includes a request for a network allocation vector (NAV) setting associated with a shared transmission opportunity (TXOP);
output a second frame triggering the shared TXOP; and
communicate, during the shared TXOP, in accordance with the request.

10. The apparatus of claim 9, wherein the request includes a field that indicates selection of the NAV setting, from a plurality of NAV settings having different durations.

11. The apparatus of claim 10, wherein at least a first duration of the different durations corresponds to a duration of the shared TXOP.

12. The apparatus of claim 9, wherein the request includes a field that indicates a duration for the NAV setting.

13. The apparatus of claim 9, wherein the first frame includes a request for the shared TXOP.

14. The apparatus of claim 9, wherein the request is for:
the NAV setting to be applied for just the shared TXOP; or
the NAV setting to be applied for a periodic allocation of shared TXOPs.

15. The apparatus of claim 1, further comprising:
at least one transceiver configured to receive the first frame, wherein the apparatus is configured as an access point.

16. A method for wireless communications at a first wireless node, comprising:
outputting, for transmission, a first frame that includes a request for a network allocation vector (NAV) setting associated with a shared transmission opportunity (TXOP);
obtaining a second frame triggering the shared TXOP; and
communicating, during the shared TXOP, with the NAV set in accordance with the request.

17. The method of claim 16, wherein the instructions stored in the memory and executable by the at least one processor further cause the apparatus to:
select the NAV setting, from a plurality of NAV settings having different durations; and
include, in the request, a field that indicates the selected NAV setting.

18. The method of claim 17, wherein at least a first duration of the different durations corresponds to a duration of the shared TXOP.

19. The method of claim 18, wherein:
the selected NAV setting has a second duration that is shorter than a first duration; and
the apparatus further comprises obtaining one or more signals after expiration of a NAV set according to the second duration.

20. The method of claim 16, wherein the request includes at least one of:
a field that indicates a duration for the NAV setting; or
a request for the shared TXOP.
